(19) United States
(12) Patent Application Publication
(10) Pub. No.: US 2016/0292390 A1
(43) Pub. Date: Oct. 6, 2016

(54) METHOD AND SYSTEM FOR A CUSTOMIZED DEFINITION OF FOOD QUANTITIES BASED ON THE DETERMINATION OF ANTHROPOMETRIC PARAMETERS

(71) Applicant: Michele SCULATI, BERGAMO (IT)

(72) Inventor: Michele SCULATI, Bergamo (IT)

(21) Appl. No.: 15/033,057

(22) PCT Filed: Oct. 31, 2013
(86) PCT No.: PCT/IT2013/000303

§ 371 Date: Apr. 28, 2016

(51) Int. Cl. G06F 19/00; G09B 19/00

(52) U.S. Cl. CPC G06F 19/3475; G09B 19/0092

(57) ABSTRACT

A method for the definition of a food quantity for a person is described, comprising the steps of acquiring digital data relating to a body portion of the person; then, processing the acquired digital data to determine at least one anthropometric parameter of the person; then, defining at least one customized measurement unit based on such at least one anthropometric parameter; finally, defining the food quantity based on the at least one customized measurement unit. Also encompassed in the invention is a system capable of implementing the above-mentioned method.

### FIELD OF APPLICATION

The present invention relates to the technical field of the estimation of anthropometric parameters, based on a detection of anthropometric data. Particularly, the invention relates to a system and a corresponding method for implementing a customized definition of food quantities based on the determination of anthropometric parameters.

### DESCRIPTION OF THE PRIOR ART

In the field of the definition of food or dietary quantities, for example by a dietitian physician (within such terms, a quantitative assessment of food portions may be generally included), several methods are known to indicate the recommended amounts of different types of food or beverages. In simplified and synthetic terms, a dietary/food definition involves the following steps: based on an assessment of the person (i.e., subject) for whom the food quantity has to be established, possibly within a dietary prescription, a suitable daily requirement of the nutritional principles is assessed in a specific and customized manner, in terms of macro-nutrients and micro-nutrients (for example: proteins, lipids, glucides, water, minerals, vitamins, etc.) and the corresponding energy/caloric contribution is also assessed; then, based on a knowledge of the nutritional energy/caloric contents of a plurality of single foods and beverages, the optimal nutritional requirement, previously assessed, is translated into a set of indications and/or prescriptions relating to a suggested combination of foods and beverages, in well-defined amounts, for each meal; finally, the indication of the corresponding food quantities is provided to the person.

For the latter step, which is pertinent to the aims of the present invention, it is necessary to provide with a certain precision the amount of each food, ideally in terms of weight (for example, in grams) and/or, optionally, by volume (for example, in cm³ or cc or ml). Such precise quantitative indication may however be not very practical, or may be difficult to be implemented with precision and regularity, for the person who has to follow the advised dietary regimen, who does not always have with him/her suitable measurement tools.

In order to simplify the indication, an option that is sometimes adopted is to use approximate volume units, corresponding to objects/containers of common use. In fact, while for some foods it is useful to use standard measurement units, for other foods (such as, for example fruits, vegetables, and beverages), particular volumetric unites may be used, which are standardized in the specific technical field, or approximated, such as, for example, a “cup”, which is standardized in the USA, and equal to 237 ml (i.e., 237 cc), or the “yogurt pot” (which may be, for example, of 125 cc or 150 cc), or other containers or objects of a known volume, for example, a tennis ball.

As a further simplification, in particular cases, it has also been proposed to use the anthropometric measurement unit “fist” (or “handful”), and also to subdivide it into more specific units (for example “small”, “middle” and “large”), which may be referred to conventional weight and/or volume value ranges, based on statistical assessments. For example, it is sometimes considered that a “small fist” corresponds to 126±18 g of vegetables, a “middle fist” corresponds to 159±27 g of vegetables, a “large fist” to 178±32 g of vegetables.

It shall be noticed that the known approaches provide in any case that the identification of the correspondence between the shape of fists having different sizes and the shape of the food portion is deduced through a mere visual comparison that is performed by those skilled in the art (for example, dietitians/nutritionists).

Sometimes, other dimensional units relating to a hand are used, such as, for example, the palm or back, which are however always referred to a “standard” hand, i.e., more precisely, to a hand of an “average subject”. For example, standard measurement units in the context of ISO are sometimes referred to for gloves, which however are based only on monodimensional units and provide a quite rough classification, compared to the uses considered herein.

Furthermore, through such approach, since a reference to a “standard” hand is done, the variations that can be found from subject to subject cannot be accounted for; it shall be noticed, by way of example only, that the volume of the fist of a child may be four times less than the one of an adult having a large hand (about 600 ml), which in turn may be more than twice the one of an adult having a small hand (about 240 ml). Therefore, it should be apparent that the results of the quantity indication, achievable through this known method, may be not very accurate.

Therefore, the above-mentioned anthropometric parameter “fist” may turn out to be practical for the user, but it is, on the other hand, unsatisfactory from the viewpoint of the precision of the indication, due to several reasons: besides to the approximation, which is intrinsic in a non-standard unit, a “fist” implies a further, quite rough, approximation relating to the categorization into the above-indicated levels, which leads to average values that almost never correspond to the actual dimensions of the fist of the subject for which the food quantity is indicated, which fist may vary in a quite wide range. Furthermore, the fist, as defined above, lends itself to define only the volume of a subset of foods, and it is not related to information of length or area, which may be significant too, for other types of food, e.g., to define the area of thin food slices. Finally, the fist is unsuitable to be applied to foods the shape of which significantly differs therefrom, for example slices of meat having different thicknesses, or cheese pieces.

In order to at least partially overcome the above-indicated drawback, the need is felt of a system and a method capable of providing customized anthropometric parameters, as a base for a simplified definition of food/dietary quantities.

Taking into account the type of application considered herein, it shall be apparent that complex technologies and systems applied in the medical-diagnostic field, such as, for example, computerized axial tomography, are completely unfeasible, due to the costs and complexity. Furthermore, complex measurement methods, providing for a direct action on the person's hand, or requiring long measurement times, are considered to be unsuitable.

So far as the Applicant is aware, to date, there are no systems and methods for the determination of anthropometric parameters, aimed to a simplified yet precise definition of food quantities, such as to meet the above-mentioned needs.

Therefore, the object of the present invention is to devise and provide a system and a method for a customized definition of food quantities based on the determination of anthropometric parameters, which are improved so as to meet the above-mentioned needs, and capable of at least partially obviating the drawbacks described herein above with reference to the prior art.

### SUMMARY OF THE INVENTION

Such object is achieved by a method in accordance with claim 1.

Further embodiments of such method are defined in the dependent claims 2-15.

A system, capable of implementing the method of the invention, is defined in claim 16.

Further embodiments of the system are defined in the dependent claims 17-19.

### BRIEF DESCRIPTION OF THE DRAWINGS

Further characteristics and advantages of a system and a method for a customized definition of food quantities based on the determination of anthropometric parameters, according to the present invention, will be apparent from the description set forth below of preferred implementation examples, given by way of indicative, non-limiting example, with reference to the appended Figures, in which:

FIG. 1 illustrates a simplified functional diagram of the system according to the invention;

FIG. 2 represents an embodiment of a system according to the invention;

FIG. 3 illustrates a detail of the system of FIG. 2, particularly a support for a hand, comprised in such system;

FIG. 4 represents a display window obtainable through processing means comprised in the system of FIG. 2;

FIG. 5 represents a further embodiment of a system according to the invention;

FIGS. 6-10 illustrate respective display windows provided by the system, according to an embodiment of the invention, by a graphic interface, so as to allow the user setting measures, inserting commands, displaying results.

### DETAILED DESCRIPTION

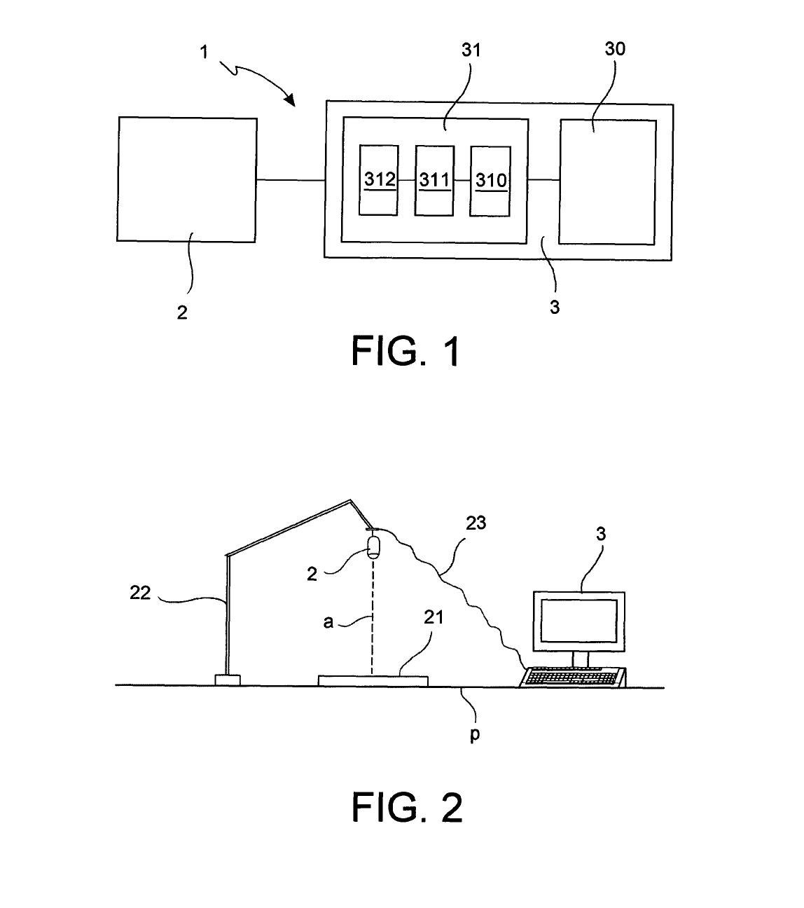

With reference to FIG. 1, a system 1 is described, according to the invention, for the definition of a food quantity for a person (i.e., subject), based on the determination of customized anthropometric parameters.

Such system 1 comprises digital data acquisition means 2, configured to acquire digital data relating to a body portion of the person, and further comprises processing means 3. The processing means 3 are configured to perform the steps of processing the acquired digital data, determining at least one anthropometric parameter of the person, defining at least one customized measurement unit based on the at least one anthropometric parameter, and finally defining the food quantity based on the above-mentioned at least one customized measurement unit.

According to an embodiment of the system 1, which will be better illustrated herein below, the digital data acquisition means 2 comprise a video camera 2, configured to acquire a digital image of the above-mentioned body portion of the subject, and to provide the processing means 3 with respective electronic signals, representative of the acquired image.

In accordance with a further embodiment of the system 1, which also will be better illustrated herein below, the digital data acquisition means 2 comprise a sensor device 2 provided with depth sensors, configured to acquire digital data representative of a depth matrix (i.e., indicative of a tridimensional representation) of the above-mentioned body portion, and also configured to provide the processing means 3 with respective electronic signals, representative of the acquired data.

According to an embodiment of the system, the processing means 3 comprise at least one computer (or a smartphone, or a laptop, or an equivalent processing device) configured to operate based on programs and algorithms stored therein, or accessible thereto in any other manner.

In a preferred implementation option, the processing means 3 are implemented by a computer 3, comprising displaying means 30 and a processor 31 (or, equivalently, multiple interacting processors).

The displaying means 30 typically comprise a display, on which a user graphic interface is projected, for example, based on windows. The user graphic interface, developed in a per se known manner, is configured both to provide results of the processing, in a graphical or numerical form, and to allow the user to insert commands/control instructions and to control the system operation.

The processor 31 typically comprises a plurality of functional modules, implemented for example by respective suitable software programs stored and operating in the processor 31.

In the embodiment of the system shown in FIG. 1, the functional modules comprise: a user interface module 310, configured to manage the above-mentioned user graphic interface, so as to supervise the reception of commands by users and the displaying of the results; an acquisition interface module 312, configured to manage the interaction, in terms of sending commands and receiving data, with the acquisition means 2; a processing module 311, operatively connected with both the user interface module 310 and the acquisition interface module 312, and configured to carry out data processing operations.

The processing module 311 is configured to perform a number of functions: for example, processing the acquired digital data, determining one or more anthropometric parameters of the person, defining a or more measurement units customized based on the respective anthropometric parameters, and defining, based thereon, the food quantity.

To this aim, the processing module 311 may be composed of multiple specific sub-modules, dedicated to single functions: for example, a data processing and anthropometric parameters determination sub-module, based on specific software programs and algorithms, and a measurement unit definition and food quantity definition 3o sub-module, configured to perform suitable measurement unit conversions and scale changes, thus creating correspondences between anthropometric measurement units and the standard ones.

The functions of the processing module 311 will be more clearly apparent from the detailed description of the method according to the invention, which will be set forth in a subsequent part of this specification.

It shall be noticed that, to the aims of the present invention, by “definition of food quantities” is meant not the dietary prescription as such, but the quantification of the quantities of an indication, in terms of customized measurement units, which are appropriate for the user. In fact, it shall be noticed that the dietary indication, in terms of, e.g., combinations of foods and beverages, precisely defined in terms of standard measurement unit and/or weight volume, are an input on which the system and the method of the invention operate. In fact, the dietary prescription, per se, pertains to a medical/dietary expertise field that oversteps the specific technical field of the present invention.

On the other hand, in a particular embodiment of the invention, it is possible that the processing module 311 is operatively connected to a further external software program for processing dietary regimens (or which simply calculates the nutritional values of a set of food portions, also to other aims) generating as an output, and providing in input to the processing module 311, a dietary prescription, or a list of food portions (also usable to non-prescriptive aims), defined in terms of weight and/or volume measurement units.

In this case, the measurement unit definition and food quantity definition sub-module is configured to establish, based on such input, the suitable anthropometric measurement unit (for example, as it will be described, a “fist” or “hand” or “finger”, the customized value of which is known from the assessment by the data processing and anthropometric parameters determination sub-module) and to convert each of the quantity quantifications from the measurement units of the conventional dietary indication to the respective suitable customized anthropometric measurement units.

The processing means 311 are configured to directly operate on the data coming from the acquisition means 2.

According to a particular implementation example, the processing means 311 are further configured to store the acquired data and to perform a post-processing on the stored data. Such post-processing is advantageously performed based on the control by the user of the system, for example, the physician, who may set different parameters to get an optimization or adaptation of the results.

Two embodiments of the system according to the invention will be described in detail herein below. In both, the body portion of which anthropometric parameters are determined is the hand, in a configuration stretched with closed fingers, or a clenched fist (i.e., closed fist), or in the shape of a “flattened fist”. Such example is not limiting with respect to the possible use of the system with other parts of the body.

With reference to the FIGS. 2-4, an embodiment is described, in which the acquisition means comprise a video camera 2.

According to a preferred implementation option, such video camera is a webcam 2, connected to a computer 3.

The webcam 2 is a small video camera that is used as an input device of the computer 3, to which it is connected, for example via cable 23 (e.g., USB). Advantageously, the webcam has a resolution e.g., equal to or higher than 1.3 Megapixel, a value that the Applicant determined to be sufficient to ensure a measurement precision that is suitable for the objects.

To ensure the interoperability with the computer 3, it is necessary that a suitable to acquisition interface module 312 is loaded to the computer, which, in this case, is a driver, typically a Windows® driver, made commercially available by the webcam manufacturer. The above-mentioned driver is installed in the computer, for example, in the Windows® operating system. The processing module 311, i.e., the software library developed to implement the method of the invention, in this case, is configured to interface (for example, by means of the Windows®“avicap32.dll” library) with any webcams having a Windows® driver.

In this case, the electronic signals provided by the webcam to the computer are not parameters expressed in the decimal metric system, but it is a graphical image, i.e., a photography, which the webcam acquires.

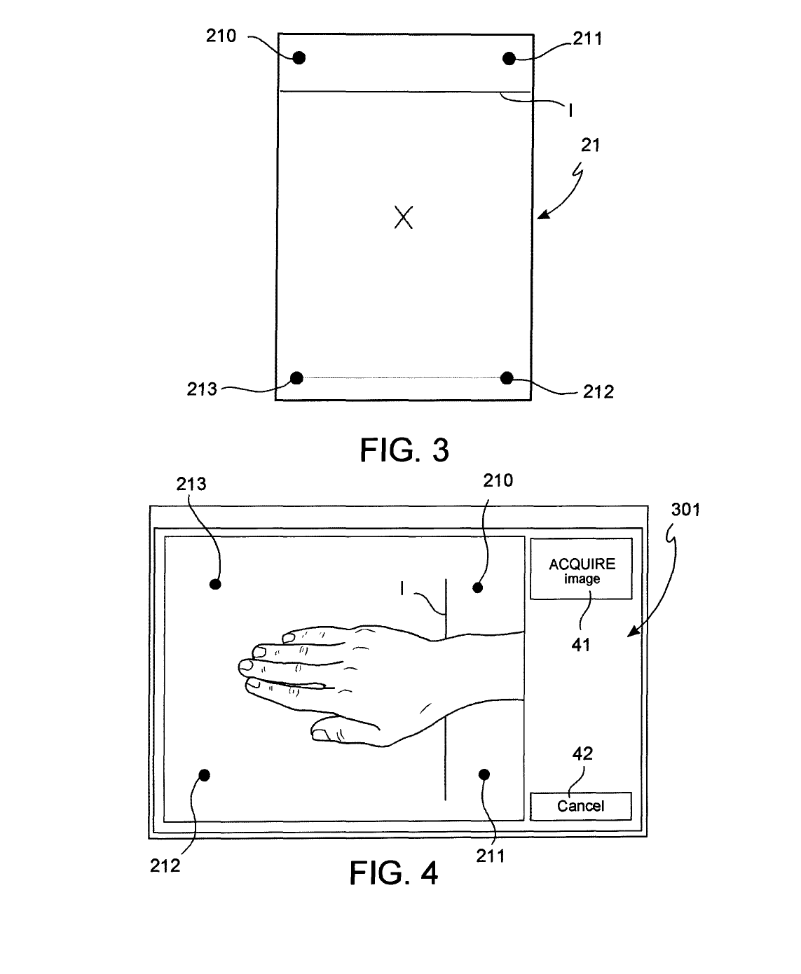

In the embodiment described herein, the acquisition means 2 further comprise a hand support 21, illustrated in FIG. 3, having a respective support plane (referred to as “p”). The webcam 2 is arranged, with respect to the support plane p, so that the framing axis (referred to as “a”) of the webcam is perpendicular to the support plane p, thus, to the hand support 21.

Preferably, the hand support 21 is located on a horizontal plane p, and the webcam 2 is arranged above such plane p and with the framing axis “a” perpendicular to such plane.

Furthermore, the webcam is arranged at such a distance (i.e., in this case, at such a height) with respect to the support plane as to allow a full and proper framing of the hand support 21. From the empirical tests that have been carried out, it resulted that an adequate distance between the webcam and the support plane is about 30 cm.

The appropriate positioning of the webcam 2 to the hand support 21 may be obtained, for example, by providing a webcam support 22, resting ob and integral to the support plane p of the support 21, and such as to support the webcam 2 and to keep it in a proper position, according to the criteria indicated above.

In accordance with an alternative implementation option, the support plane of the support 21 is vertical, and the webcam 2 is supported at a suitable distance on a horizontal plane, so as to have a horizontal framing axis.

It is noticed that the hand support 21 may perform the further important function of establishing a spatial reference system, including a spatial measurement scale, in order to allow interpreting the image acquired by the webcam and measuring the anthropometric values.

According to an implementation example, illustrated in the top view of the support 21 set forth in FIG. 3, four dimensional reference points are depicted on the hand support 21, i.e., the four dots 210-213, arranged in preset positions, the respective mutual distances being also known. For example, the four dots 210-213 are arranged to form a square into which the hand to be measured shall be located. Furthermore, on the support 21, a central point, conventionally indicated with X in FIG. 3, is depicted in or near the barycenter of the square. The reference points indicated above allow an appropriate positioning of the hand the data of which have to be acquired: the hand has to be located within the dimensional reference dots, and it has to cover the central point.

A wrist cut line (“I”) may also be depicted on the support 21, indicating the line at which the wrist has to be arranged.

It shall be noticed that the support 21 is characterized by a different, and preferably very different, background colour, from an expected nominal colour of the hand (for example white-rosy).

The reference signs on the support (dimensional reference dots, central point, wrist cut line) are characterized by one or more different, and preferably very different, reference colours with respect to the above-mentioned background colour, and with respect to the colour of the hand.

In order to properly interpreting the images acquired by the webcam 2, some initial information is stored in the computer 3, for example, in the processing module 311: particularly, the dimensions of the square defined by the dots 210-213 (for example, dimensions defined in mm, stored in a “Settings.ini” file), as well as the background colour and the reference colours (colours that are stored for example, in the RGB format, in a “Colori.ini” file). Storage of colours may be performed and/or updated by a recalibration of the webcam 2, by means of a function provided by the user interface module 310, which can be managed by the graphic interface of the computer 3.

The functions performed by the system 1, in the embodiment described herein, are illustrated herein below.

The processing module 311 is configured to read first the above-mentioned Settings.ini and Colori.ini setting files.

Then, the webcam 2 acquires an image of the support 21 and of the hand, and transfers the acquired data to the computer 3, which is capable of both displaying the image (e.g., in a first processing window 301, as shown by way of example in FIG. 4), and processing the data. Advantageously, the user may control or cancel the acquisition of the displayed image, by clicking on respective icons 41, 42 of the window 301. From this first window 301, optionally, the user may specify the wrist cut line by indicating the coordinates of any two points of the line, (x1, y1) and (x2, y2). The processing module 311 calculates the equation of the straight line corresponding to the wrist cut line, in the form:

y=a·x+b

in which the parameters a and b are calculated as:

$$a = \frac{y 1 - y 2}{x 1 - x 2}$$

$$b = y 1 - a \cdot x 1$$

Then, the processing module 311 processes the image data so as to recognize the is dimensional reference dots, by knowing the respective reference colour.

For each of the dots, the image is inspected, pixel by pixel, starting from the angle of the corresponding image, and all the points having a colour similar to the respective reference colour are stored. From the thus-obtained point cloud, the points that are too far from all the other ones, which is typically due to noise phenomena (for example, generated by reflections or polished nails) are discarded. Then, the barycenter is calculated of the cloud of valid points that have been found; such barycenter will be considered as the coordinate of the respective geometric reference point. The procedure is repeated for each of the four dots 210-213, allowing to define the coordinates (x_{r,i}, Y_{r,i}) of each of the respective four reference points.

Furthermore, the processing module 311 measures the distance, expressed in pixels, between each pair of dots, which have at this point known coordinates, and compares it with the distance, expressed in mm, stored in the “Settings.ini” file, to obtain the mm/pixel ratio of the acquired image.

Then, the processing module 311 further processes the image, ignoring all the external points with respect to the user-specified wrist cut line; the colour of the external points to be ignored is transformed into the background colour.

Then, the processing module 311 calculates the barycenter of the square defined by the reference dots. Preferably, taking into account that the dots could define not a square, but a parallelogram (for example, in the case where the webcam 2 is not perfectly in vertical axis to the barycenter), the barycenter is calculated as the intersection point of the diagonals, the equation of which is known, being known the coordinates (x_{r,i}, y_{r,i}).

Such barycenter is coincident with or very near to central point that has to be covered by the hand; therefore, the image pixel having the coordinates of the barycenter certainly belongs to the hand. The processing module 311 reads the colour of such pixel and interprets and stores the read colour as the hand colour, in an accurate way, taking into account particular image acquired.

Once the hand colour (obtained as described above) and the background colour (stored in the configuration step) are known, the processing module 311 samples the image and analyses each pixel thereof, by reading the colour thereof. Then, for each pixel, it is decided whether it belongs to the hand image or not, according to the fact that the colour of the pixel is more similar to that of the hand or to that of the background.

Optionally, in order to achieve such decision, the read color is converted into the HSV (Hue Saturation Value) format, and only the hue component is taken into account for the comparison.

At the end of the above-mentioned step, the processing module 311 has the coordinates of all the points (pixels) belonging to the hand. The dimensions of each pixel, as already noted, are known, therefore, the area thereof is known.

At this stage, the value of the area occupied by the hand is precisely calculated, by the processing module 311, as the sum of the areas of all the pixels recognized as belonging to the hand.

Furthermore, different monodimensional values can be calculated, for example, lengths or widths. Typically, the distance between the most extreme coordinates of the pixels recognized as belonging to the hand is calculated, and such distance may be considered as the hand length.

In different implementation options, also encompassed in the invention, other different monodimensional and bidimensional measurements can be obtained from the set of the pixels of the hand.

In a further implementation example, the processing module 311 is further configured to estimate a volumetric value or another tridimensional measure of the hand. For example, the hand volume may be calculated based on statistical correlation data between length and area of the hand, and volume of the hand.

In order to estimate the hand volume, starting from the bidimensional value of the area of the hand surface measured by the webcam, the following equation (empirically defined) can be for example used:

Hand Volume=(3,9495*Hand Area)−215,38

in which the volume is expressed in cm³ and the area is expressed in cm².

It shall be noticed that the solution described herein allows obtaining a considerable advantage as regards the precision of the customized estimation, also with reference to the parameter “hand volume”, although such parameter is herein calculated, and not measured.

In fact, firstly, it should be pointed out that the numerical quantification of the hand volume offers a more accurate information compared to the known solutions, that are based on a simple visual comparison, resulting from a mere observation, between hands having different sizes and the correspondence thereof in terms of their shape with respect to portions of different foods.

Furthermore, in the present embodiment, the calculation of the volume is carried out by means of a processing based on a measured parameter (hand area).

Again, the equation set forth above allows a better assessment compared to estimations carried out based on known, generic, non-customized correlation formulae, for example, between hand length and volume. In fact, based on an empirical measurement study performed by the Applicant, comprising 300 measured data of area and volume of hands having different sizes, the equation set forth above shows a good correlation, with a parameter R² equal to 0.85. On the contrary, on the same sample of measured hands, the correlation between hand length and volume showed a sensibly lower correlation (a parameter R² of 0.67), i.e., a precision that is believed to be insufficient to the aim of using the datum for the objects of the invention.

The embodiment of the system, described above, allows to display and process the image of the hand acquired by the webcam, to precisely measure length and area of the hand and to estimate the hand volume (i.e., to deal with customized monodimensional, bidimensional, and tridimensional anthropometric parameters).

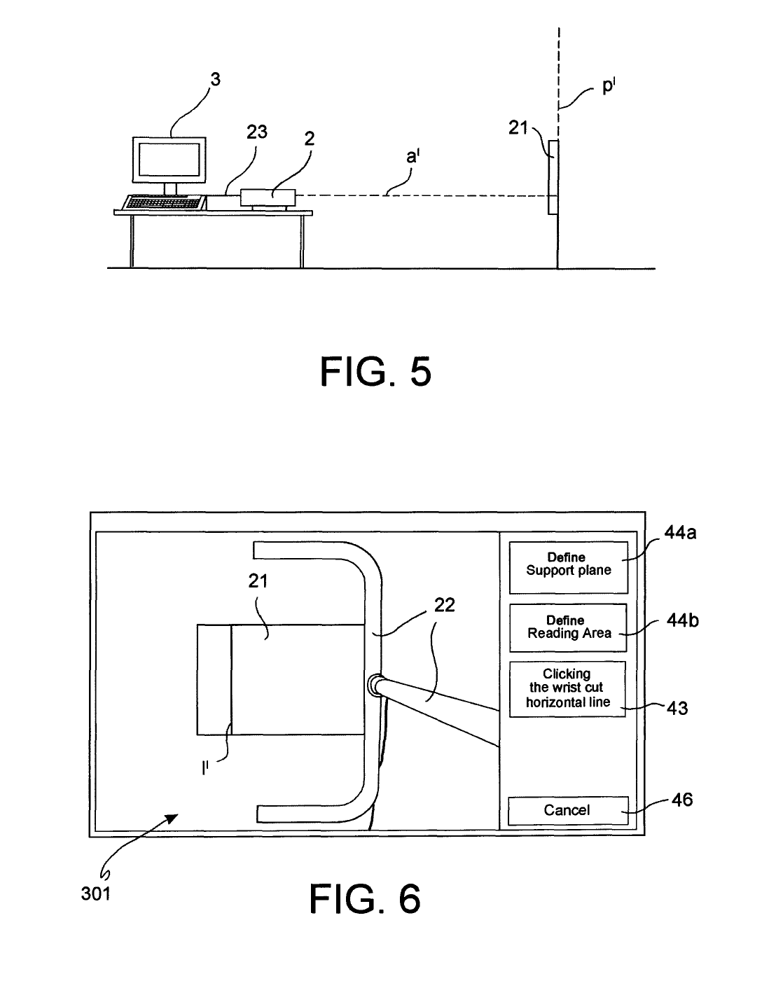

With reference to the FIGS. 5-10 (and to the general scheme of FIG. 1), a further preferred embodiment of the system of the invention will be now described, in which the acquisition means comprise a sensor device 2 provided with depth sensors.

In accordance with an implementation example, the depth sensor may comprise a laser.

According to an implementation option of the embodiment described herein, the sensor device 2 is a Microsoft® Kinect 2 device (referred to herein below simply as Kinect), which is connected to a computer 3.

The Kinect device is a commercial device comprising, inter alia, a RGB video camera with a resolution of 640×480 pixels, an infrared (IR) depth sensor with a resolution of 320×240 pixels, and a USB data connection 23, suitable to allow the connection with the computer 3.

In order to ensure the interoperability with the computer 3, it is necessary that a suitable acquisition interface module 312 is loaded in the computer, which in this case is a Kinect interfacing driver, commercially available and freeware.

More specifically, such driver comprises two parts, both of which being commercially available: the driver of the Kinect device, and a basic data processing platform (“framework OpenNI”) allowing to have, based on a detection by the sensors, a numerical depth map, where the values have already been converted into standard measurement units (mm).

In this case, advantageously, the electronic signals provided in input to the processing module 311 of the computer 3 are composed by the above-mentioned depth map, i.e., by a bidimensional matrix containing a single value of distance for each point measured by the Kinect.

In the embodiment described herein, as shown in FIG. 5, the acquisition means 2 further comprise a support for the hand 21, illustrated in FIG. 5, having a respective support plane (referred to as “p′”). The Kinect 2 is arranged, with respect to the support plane p′, so that the framing axis (referred to as “a′”) of the Kinect is perpendicular to the support plane p′, and thus to the hand support 21.

Preferably, the hand support 21 is arranged on a vertical plane p′ and the Kinect 2 is rested on a horizontal plane, with the framing axis being perpendicular to the plane p′.

In accordance with a different implementation example, the support plane of the support 21 is horizontal, and the Kinect 2 is supported and kept in a fixed and preset position, by a special support, above such horizontal plane, so as to have a vertical framing axis. The display windows shown in the FIGS. 6-10 refers to such implementation example.

Although the detailed operation of the present system is described herein below with reference to the case when the framing axis “a” and the support plane p′ are perpendicular, alternative embodiments, also encompassed in the invention, provide that the framing axis “a” and the support plane p′ can be mutually inclined of any angle α, ranging between 0° and 90°.

From empirical test carried out, and from intrinsic characteristics of the Kinect device, it has been found that a proper distance between Kinect and the hand support plane, in order to take precise depth measurements, has to be equal to or higher than 50 cm. Preferably, such distance ranges between 55 and 70 cm.

In this embodiment, the support 21 may be any surface (for example, a support secured to wall, or rested on a table) provided that it is smooth, and having any dimensions, provided that they are sufficient to contain a hand: preferably, the support 21 has a minimum width of 25 cm and a minimum height of 30 cm.

Furthermore, in this case, there are not particular requirements about the background colour.

Preferably, the support 21 surface is a non-reflective surface, and more specifically a surface such as not to reflect infrared rays. For example, the support 21 may be made of opaque materials, such as paper, or cardboard, or opaque plastic, or wood.

Advantageously, a wrist cut line (indicates as “I”), indicating the line at which the wrist has to be arranged, may be depicted on the support 21. In this case, such line has only the function of indicating the position of the hand on the support, and not to provide a spatial reference system for processing the image.

The bidimensional plane dividing the hand from the wrist, in this case, is configured by means of a proper command to the computer, through the graphic interface. For example, the computer 3 is configured to display a first display window 301 with an image of the support 21, without the hand, and to allow the user to recall a “wrist cut setting command” (icon 43), allowing to define the wrist cut by clicking onto the support image at the wrist cut line. Consequently, the processing module 311 calculates the equation of the wrist cut plane (which turns out to be a plane x-z, in the hypothesis that the support plane is a x-y plane, and in which the framing axis a of the Kinect is aligned with the axis z). After defining the wrist cut plane, the processing module 311 will perform all the subsequent processing operations only on those data corresponding to the hand portion laying below the wrist cut line.

The functions carried out by the system 1, in the embodiment described herein, are described herein below.

In an initial configuration step, some initial information is stored in the processing means, such as the bidimensional coordinates of a starting point for searching the support plane p′ (for example, in a “planePoint.ini” file) and the equation of the wrist cut plane or, equivalently, of the straight line corresponding to the wrist cut line (for example, in a “wristPointini” file).

The processing module 311 is configured to read first the above-mentioned initial information.

Then, to estimate the support plane p′, the processing module 311 is configured to carry out a series of detections, in the absence of the hand. More specifically, starting from the known initial point, a small bidimensional square (or “limiting square” or “bounding box”) is generated, with a few pixels long side, around the starting point read before. For each vertex (i.e., bidimensional, or 2D, point) of such square the corresponding depth measure is read, and it is tried to extend the vertex point in successive steps of 1 pixel until when the difference between the depth measured for the extended point and the depth of the preceding point exceeds a preset value (for example, 10 mm). The expansion of the limiting square is further constrained by not exceeding the wrist cut coordinate. Once such condition has been reached, the successive vertex of the limiting square is considered, and the procedure is iterated. After extending all the vertices as indicated above, it is certain that all the points (2D) within the “extended limiting square” belong to the support plane to be estimated.

Once the reading area (2D), for each point (2D) has been determined, the depth value is read, and the corresponding tridimensional point (3D) on the support plane is identified. Then, the barycenter of the set of identified 3D points is calculated, and such barycenter is considered as the origin 3D point for the equation of the plane.

Then, the normal to the support plane is calculated, starting from the above-mentioned plane origin point and having a direction as the axis z. The calculation of the normal provides, for example, dividing the “extended limiting square” into eight bidimensional triangles; for each vertex of each bidimensional triangle, the corresponding tridimensional point is calculated by reading the depth measurement, thus obtaining eight respective tridimensional triangles, for each of which the normal is calculated through the formula of the scalar product of the sides; the normal of the support plane is calculated as the normalized average of the eight normals calculated above.

Finally, by knowing the origin point and the normal, determined as set forth above, the equation of the hand resting plane p′ is calculated and stored.

According to a further embodiment, illustrated in FIGS. 6-9, the support plane p′ and the reading area of the processing module 311 are set by the user before using the system. Such solution may solve or attenuate possible problems deriving from the presence of reflective surfaces contiguous to the position intended to the hand. In such a case, the reading area 210 may be a limited reading rectangle, which is sufficiently large to contain hands having any predictable size. The setting by the user may be, for example, carried out through the graphic interface and optionally graphic aids available in such interface; particularly, through the icon 44a of the first display window 301 shown in FIG. 6, the user may define the support plane p′; through the icon 44b, in the same window, the user may define the reading area by clicking onto two opposite vertices of the reading rectangle (for example, top right, and bottom left).

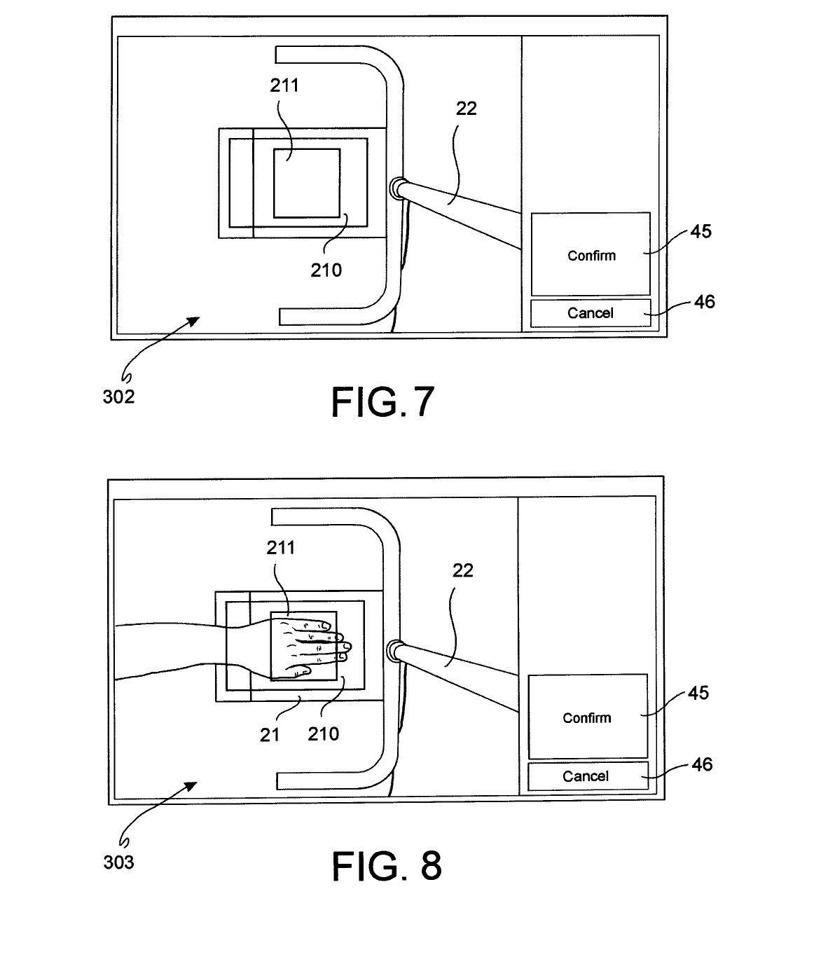

Consequently, the graphic interface of the system is configured to display to the user a second display window 302, shown in FIG. 7, in which the set reading area 210, and optionally a further sub-area 211 (also settable by the user) that defines more specifically the position intended to the hand, are highlighted

Subsequently, the sensor device 2 (Kinect) performs further detections, before the hand is positioned, to determine the depth matrix (which is stored as “background depth”) of an area read by such device that is defined, inter alia, by the wrist cut line.

At this stage, the detections are carried out in the presence of the hand, i.e., the measurements of the tridimensional image corresponding to the body portion the anthropometric parameters of which have to be estimated.

Particularly, the depth matrix to be processed is determined and stored.

As the depth matrix to be processed, it is possible to use a single measurement or, preferably, the mobile average of each depth, measured including a plurality of measurements (for example, the last ten measurements).

In order to acquire the digital data of the hand, the hand is arranged (i.e., placed) on the support 21, in a suitable position. The system graphic interface is configured to display a third display window 303 (see FIG. 8) in which an image of the hand with respect to the above-defined reading area is shown, and the proper positioning of the hand can be verified. The commands of acquisition confirmation or acquisition cancellation are set by the user by means of the corresponding two icons 45, 46.

The successive processing is still based on the “limiting square” and “extended limiting square” quantities, defined above.

For each 2D point of the “extended limiting square”, the depth measurement is read by obtaining the 3D point belonging to the hand surface (referred to as the “point1”) and a second 3D point (referred to as the “point2”) using instead, as the depth, the “background depth”, determined as described above.

For the calculation of the anthropometric parameters, only the 2D points of the “extended limiting square” for which the 3D point “point1” is in front of the 3D point “point2” are considered valid and usable. In this manner, a set of valid points is determined.

For each point of the set of valid points, the area “occupied from the point” is calculated. It is worth remembering that, although a geometric point is non-dimensional by definition, the images detected by computer devices (as a webcam or Kinect) are not formed by continuous values, but by sampled values. Each sampled point (pixel) summarizes the value of a small area the horizontal and vertical sides of which are obtained by dividing the physical width of the represented image by the horizontal and vertical resolution, respectively, of the device. In the case of the Kinect device, the dimensions of the measured area and the resolution are directly provided by the above-mentioned “framework OpenNI” software.

The area of the hand is calculated as the sum of the areas “occupied” by all the points belonging to the set of valid points.

The volume of the hand is calculated as the sum of the “elementary volumes” of the parallelepipeds corresponding to the points belonging to the set of valid points. Each of such parallelepipeds has a base area that is equal to the “occupied area” of the respective single point (pixel) and, as the height, the detected depth value at the same point.

According to an implementation option, the above volume calculation is further refined by taking into account the perspective effect of the depth, i.e., by measuring the volume not of a parallelepiped, but of a trunk of a pyramid having as vertices the projections of the ends of the pixels on the background plane.

Besides to tridimensional (e.g., the above-mentioned hand volume) and bidimensional (e.g., the above-mentioned hand area) anthropometric parameters, one may calculate several monodimensional values (for example, lengths or widths). In an example, the distance between the most extreme coordinates (x and/or y) of the points belonging to the set of valid points is calculated, and such distance may be considered as the hand length. In another example, among all the points of such set, the points having the highest and lowest y values are selected, respectively; then, the length of the straight line segment joining them is calculated, and the measure of such segment is considered as equal to the hand length.

In a particular implementation variant, the volume, area and length measurements are averaged based on ten stored measurements, and they are considered as stable when the standard deviation of the last forty measurements is lower than a preset value (typically, equal to 7.5).

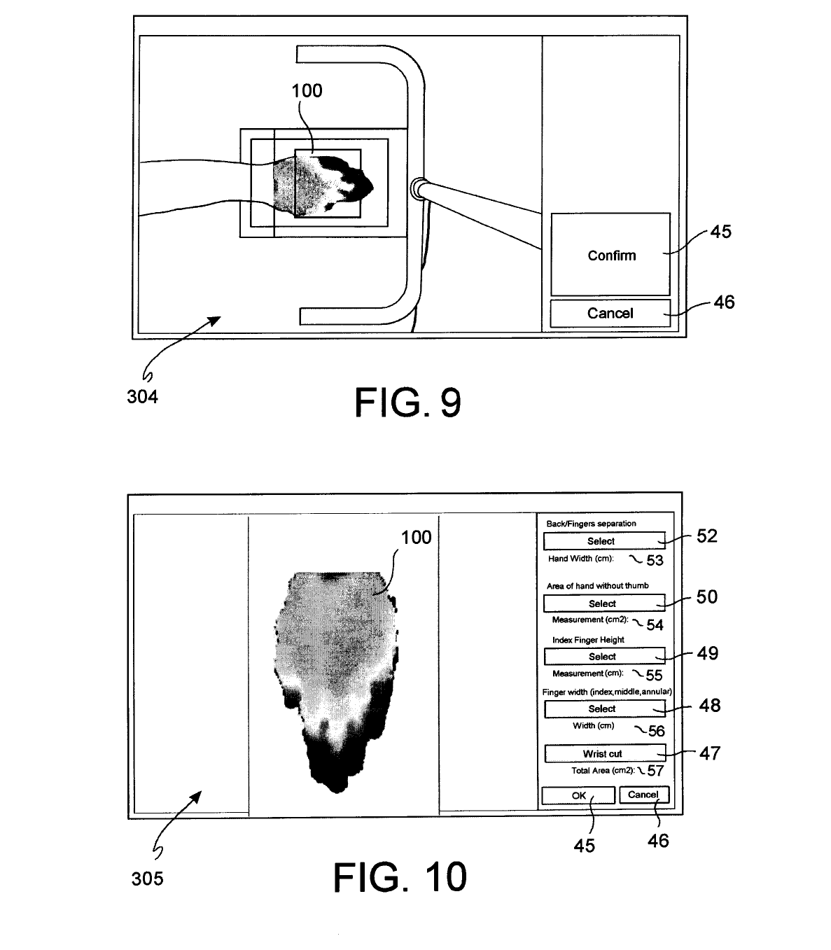

In accordance with an embodiment, the system 1 is further configured to calculate further anthropometric parameters, in a controllable manner depending on a plurality of criteria desired by the user. To such aim, the computer 3 is configured to carry out a post-processing on the acquired data. Particularly, the computer 3 is configured to show, on demand by the user, a fourth display window 304 and a post-processing window 305 (shown in FIGS. 9 and 10, respectively), in which a selected and processed hand image 100 is displayed. The depth of the several points is represented by a colour code (several tones of grey, in the FIGS. 9 and 10; in reality, the colour scale may range from red, for a low depth, to blue, for a high depth). In the post-processing window 305 a plurality of icons 47-52 is provided, to give the user the possibility to select a number of post-processing functions/measurements (such as those that will be mentioned herein below) and the measurements corresponding to the selected anthropometric parameters are further displayed, through special writings 53-57.

In the example illustrated in FIG. 10, the following post-processing functions are implemented.

The function “wrist cut” allows the operator (after clicking on the icon 47) to manually select the “wrist cut” line on the image 100, in order to improve the distinction between the surface corresponding to the hand and the one corresponding to the forearm of which the wrist line marks the dividing line.

The “total area” function allows displaying, by means of the writing 57, the total hand area value, taking into account the wrist cut line (the total hand area is calculated depending on the wrist cut line specified by the user).

The “back-fingers separation” function allows the operator (after clicking on the icon 52) to trace on the image 100 the separation line between the back and four fingers of the hand (excluding the thumb); in response to this, the measurement of the hand width (shown in the writing 53) is carried out, and also, optionally, the measurements of the hand back area and the area of the four fingers (without thumb), as well as the measurement of the length of the middle finger (or of any of the other fingers). It is noticed that, by “length of a finger”, is meant the length of the segment starting from the crossing between the separation line between the back of the hand and the fingers, at the joint between the metacarpal bones and the first phalanx (or proximal phalanx), and the apical point of the nail of the respective finger.

The “area of the hand without thumb” function allows the operator (after clicking on the icon 50) to indicate on the image 100 the separation line between the thumb and the remaining part of the hand, as a preparatory step to the measurement of the thumb surface and, by difference, of the hand without thumb (that is displayed, in the example of FIG. 10, by the writing 54).

The “index finger height” function allows the operator (after clicking on the icon 49) to select on the image 100 a point of the index finger, and to carry out a measurement of the height (i.e., the “thickness”) of such finger, and display it in the writing 55. More specifically, such function allows measuring the height (or thickness) of the finger intended as the segment going from the nail surface to the opposite face of the finger. Furthermore, such measurement can be calculated as the average of the depth values around a radius of 5 pixels; depth values of 0 are excluded in the average calculation. Similarly, the measurements of the height of other fingers can be determined.

The “index-middle-annular finger width” function allows the operator (after clicking on the icon 48) to specify a sectioning line comprising such three fingers, to measure on such sectioning line the width of each of the three fingers. More specifically, such function allows measuring the width of the fingers meant as the length of the segment going from the middle margin to the side margin of a finger at the second phalanx. This may be obtained, in diverse options, by dividing by three the overall width value of the three fingers (thus obtaining an average value, illustrated by the writing 56); or providing the user with the possibility of specifying multiple sectioning lines, in order to precisely indicate, finger by finger, the width to be measured.

The above-mentioned list of functions is to be meant as exemplary, and not complete. Other measurements can be carried out, in accordance with further implementation examples. For example, the computer 3 may be further configured to directly measure the width of the “span”, intended as the distance between the apex of the thumb and the little finger of a stretched hand with the fingers wide apart. Such measurement may be useful, for example, to estimate the diameter of a pizza.

A further function available in the system is to configure, through a respective command, the mutual position forearm-hand with respect to the position of the sensor device: above, right, under, left. In such a manner, it is possible to use the system with reference to different positions of the subject the anthropometric parameters of which have to be estimated. The computer 3 processes in this case the detection of the processing module by taking into account the insertion direction, and performing suitable corrections/rotations before displaying the hand.

According to further particular embodiments of the system, the computer 3 is further configured to directly measure the volume of the “clenched fist” and the “flattened fist”, by virtue of the fact that the subject puts onto the support not a stretched hand with closed fingers, but, respectively, the “clenched fist” or the “flattened fist”.

It is noticed that by “clenched fist” (or “closed fist”, or simply “fist”) is meant the position in which the first, second, and third phalanges of the index, middle, annular, and little finger are bent until the compression between them prevents a further flexion thereof; the thumb is rested onto the support plane and simply pulled over until touching the index finger at the joint between the first and second phalanges.

It is also noticed that by “flattened fist” (or “knuckle flattened handful”) is meant the position in which the first phalanx of the index, middle, annular, and little fingers is in the maximum stretched position with respect to the corresponding metacarpal bones, while the second and third phalanges of the index, middle, annular, and little fingers are bent until the compression between them prevents a further flexion thereof; the thumb turns out to be rested onto the resting plane and simply pulled over until touching the middle part of the hand palm.

It shall be noticed that, for precision's sake, the “clenched fist” and “flattened fist” volumes are mutually different, and different from the volume of the stretched hand with closed fingers. In fact, the “clenched fist” and “flattened fist” volumes also include the empty gaps that are formed between a support plane and the hand, and the empty gaps that are formed within the fist itself. Such empty gaps increase according to the shape into which the hand is arranged.

It shall be also noticed that, in the context of the present invention, the possibility of precisely estimating the volume of the fist (closed or flattened), besides to that of the open hand, is very advantageous. In fact, the fist volume is the volume that the subject perceives when observing the volume of his/her own limb and comparing it to the volume of the food portion that he/she is going to quantify.

In view of providing a simplified manner for quantifying the quantity, it is convenient to have several anthropometric parameters to be proposed (for example, hand, closed fist, flattened fist), each of which is precisely measured, as described above.

According to other particular embodiments of the system, the computer 3 is further configured to calculate in post-processing and display, in other screens, not shown, further data and/or measurements and/or volumetric parameters, relative to the “stretched hand with closed fingers” and/or “clenched fist” and/or “flattened fist” conditions.

Particularly, in the case where the stretched hand with closed fingers is measured, it is possible to obtain the direct measurements of: hand volume; hand area; hand length. Furthermore, through suitable post-processing operations on the acquired data, e.g., a direct measurement for exclusion or a processing of specific measured areas, it is also possible to obtain the measurements of: hand area without thumb; width of a finger; height of a finger; length of the middle finger; area of a finger; hand width; area of hand back.

Incidentally, it shall be noticed that the same parameters as indicated above can be measured, in a similar way, during a post-processing stage, also in the embodiment of the invention in which the sensor device is a webcam, except for “finger height”, “clenched fist volume” and “flattened fist volume”, which are instead determined, by a calculation, through parametric equations the parameters of which are empirically quantified.

By way of example, the “finger height” parameter can be suitably calculated by the equation:

Finger Height=0.0477x+4.5116

where the variable x indicates the hand area.

The “clenched fist volume” parameter can be suitably calculated by the equation:

Clenched fist Volume=1,017x+4,564

where the variable x indicates the hand volume.

The “flattened fist volume” parameter can be suitably calculated by the equation:

Flattened fist Volume=1,110x−4,212

where the variable x indicates the hand volume.

Again with reference to the system 1, it shall be finally noticed that, in all the embodiments described above, the processing module 311 is further configured to carry out conversions between a plurality of “standard measurement unit” and “anthropometric measurement unit” pairs (their possible combinations are several), by considering as the respective proportionality coefficient the measurement of the corresponding anthropometric parameter carried out by the system and expressed in the desired standard measurement unit. Therefore, based on the carried out conversion and knowing a quantity in the standard measurement unit, the processing module 311 is capable of calculating and providing in output the above-mentioned quantity expressed in the anthropometric measurement unit.

The choice of using, for example, a clenched fist or a flattened fist depends on the shape similarity that a particular amorphous food may show with respect to the clenched fist or flattened fist; the system is set to also insert multiple reference units for a single food, if this is considered as useful.

A method for the definition of a food quantity for a person, according to the invention, will be now described. Such a method, in its different embodiments, can be implemented by the system of the invention described above.

The method comprises the steps of acquiring digital data relating to a body portion of the person; then, processing the acquired digital data to determine at least one anthropometric parameter of the person; then, defining at least one customized measurement unit based on such at least one anthropometric parameter; finally, defining the food quantity based on the at least one customized measurement unit.

According to an embodiment, the above-mentioned digital data acquisition step comprises the steps of defining a spatial reference system; then, arranging (i.e., placing) the body portion in a known position with respect to such spatial reference system; then, acquiring as digital data a digital representation of the body portion with respect to the spatial reference system.

In accordance with a particular implementation example, the above-mentioned step of defining a spatial reference system comprises providing a support 21 suitable to define the spatial reference system; the step of arranging the body portion provides for arranging such body portion on the support 21; and the step of acquiring a digital representation comprises acquiring a digital representation of the body portion and of at least one part of the support 21.

It shall be noticed that the spatial reference system may be obtained also without a physical support, in different implementation options, for example by using two or more sensor devices, in known positions, and processing the data coming from both.

In accordance with an embodiment of the method, the digital data processing step comprises the steps of determining a reference coordinate system corresponding to the above-mentioned spatial reference system; then, recognizing in the acquired digital representation a plurality of points corresponding to the body portion; then, estimating the coordinates of the plurality of points corresponding to the body portion, with respect to the determined reference coordinate system; finally, calculating the at least one anthropometric parameter based on the estimated coordinates.

In an embodiment of the method, the at least one anthropometric parameter corresponds to a monodimensional dimension of the body portion, and the step of defining at least one customized measurement unit comprises defining a length measurement unit.

In an embodiment of the method, the at least one anthropometric parameter corresponds to a bidimensional dimension of the body portion, and the step of defining at least one customized measurement unit comprises defining an area measurement unit.

In an embodiment of the method, the at least one anthropometric parameter corresponds to a tridimensional dimension of the body portion, and the step of defining at least one customized measurement unit comprises defining a volume measurement unit.

In accordance with an embodiment of the method, a plurality of anthropometric parameters is determined, each of which corresponding to a monodimensional dimension, or to a bidimensional dimension, or to a tridimensional dimension of the body portion; and the step of defining at least one customized measurement unit comprises defining a plurality of respective customized anthropometric measurement units, i.e., length, or area, or volume measurement units, respectively.

According to an embodiment, the step of defining the food quantity comprises the steps of defining the food quantity in terms of a standard volume or area or length unit; then, converting the standard volume or area or length unit to the above-mentioned corresponding customized measurement volume, area, or length unit, respectively; finally, expressing the food quantity in terms of such customized measurement volume, area, or length unit.

According to a preferred embodiment of the method, the body portion is a hand.

According to alternative embodiments, the body portion is another body portion, different from the hand.

In the case where the body portion is a hand, different implementation options of the method provide that the volume measurement unit corresponds to the volume of the stretched hand with closed fingers, or to the volume of the hand arranged as a clenched fist, or to the volume of the hand arranged as a flattened fist, or to the volume of the fingers or to a volume obtained by multiplying a measured surface by a measured monodimensional length.

In accordance with an embodiment of the method (that can be implemented, particularly, by a system comprising a video camera), the support 21 is characterized by a background colour that is different from a nominal colour of the body portion; the spatial reference system is a bidimensional reference defined by a plurality of reference points 210-213, X, marked on the support 21 with a reference that is different from the background colour and the colour of the body portion; the respective reference coordinate system is a system of bidimensional coordinates based on the coordinates of each of such plurality of reference points; the acquired digital representation is a bidimensional image composed by pixels, acquired by a video camera 2. In such embodiment, the method comprises the further steps of examining the image pixels in order to determine the colour thereof; then, carrying out respective comparisons between the colour determined for each of the examined pixels and each of the background colour, the reference colour, and a predefined colour expected of the body portion; finally, recognizing the plurality of reference points and the plurality of points belonging to the body portion, based on such comparisons.

According to different implementation examples of the above-mentioned embodiment, the anthropometric parameter calculation step may comprise the step of calculating a distance between two end points, between the points recognized as belonging to the body portion, and considering the calculated distance as a length of the body portion; or, the step of calculating the sum of the single areas of the pixels corresponding to the points recognized as belonging to the body portion, and considering the area calculated as an area of the body portion surface. In a further implementation example, the method further encompasses the step of estimating the body portion volume, by a predefined algorithm, based on the calculated area and length of the body portion.

In accordance with an alternative embodiment of the method (that can be implemented, particularly, by a system comprising a depth sensor device), the support 21 is a support plane inclined by a known angle ranging between 0° and 90° with respect to the horizontal plane; the spatial reference system is a tridimensional reference defined by a reference plane, related to said support plane; the respective reference coordinate system is an equation representative of such reference plane; the acquired digital representation is a tridimensional representation composed of pixels having tridimensional coordinates, which are acquired by a sensor device provided with depth sensors. In such a case, the method comprises the further steps of determining a first depth matrix of a zone (i.e., region) scanned by the sensor device, in the absence of the body portion on the support; then, determining a second depth matrix of the zone scanned by the sensor device, in the presence of the body portion on the support; finally, recognizing the plurality of points belonging to the body portion, based on a processing carried out on the above-mentioned first and second depth matrices.

In a preferred implementation option of the above-mentioned embodiment, the support plane is a plane substantially vertical, inclined by an angle substantially equal to 90° with respect to the horizontal plane.

In several implementation examples of the above-mentioned embodiment, the anthropometric parameter calculation step comprises calculating a distance between two end points, among the points recognized as belonging to the body portion, and considering the distance calculated as a length of the body portion; or, calculating the sum of the single areas of the pixels corresponding to the points recognized as belonging to the body portion, and considering the area calculated as an area of the body portion; or, calculating the sum of the volumes of the single solids of the pixels corresponding to the points recognized as belonging to the body portion, and considering the calculated volume as a volume of the body portion, wherein each of such single solids is a solid defined by the surface of the respective pixel, by the projection surfaces of the boundary of the pixel surface, as seen by the sensor device, and by the surface of the projection of such pixel onto the support plane. For example, such single solid is a parallelepiped having as its base the surface of the respective pixel and, as its height, a depth value associated to such pixel.

In a particular embodiment, the method further provides the steps of defining at least one further criterion for establishing whether a point belongs or not to a body portion, and of recognizing the plurality of points belonging to the body portion, taking also into account such at least one further criterion.

Such further criterion comprises for example an assessment of the position of each point with respect to a wrist cut plane (or line).

In accordance with a particular embodiment of the method, the steps of calculating a to distance between two end points, or calculating the sum of the single areas, or calculating the sum of the volumes of the single solids, are iteratively repeated; the respective body portion length, or body portion area, or body portion volume, are calculated as an average or a standard deviation of the results of a plurality of such iterative repetitions.

According to a further embodiment, the method provides a further step of post-processing the acquired digital anthropometric data. Such post-processing step allows the user indicating the desired measures, and/or establishing criteria to define the boundary conditions of the desired measurements. The measures, i.e., the anthropometric parameters, which can be obtained in the post-processing step comprise, for example, hand width, hand length, length of at least one (or of each) of the fingers, width of at least one (or of each) of the fingers, height of at least one (or of each) of the fingers, span length, area of at least one of the fingers, hand area, hand area without thumb, area of the hand back, area of the hand palm, volume of the stretched hand with closed fingers, volume of the clenched fist, volume of the flattened fist.

As it can be observed, the object of the present invention is achieved by the system and the method described above, by virtue of the characteristics thereof, illustrated above.

In fact, it shall be apparent that the present invention, by means of relatively simple and not expensive devices, and through a measurement procedure that is rapid and easily acceptable by the patient, allows estimating with precision, and in a customized manner, a desired set among a wide plurality of anthropometric parameters (among which, for example, as described above, hand volume, closed or flattened fist volume, area of the back or palm of the hand, area of the entire hand, hand length, length of the fingers, width of the fingers, height of the fingers, etc.). Each of these anthropometric parameters is easily associated to a respective customized anthropometric measurement unit.

The customized anthropometric measurement units of the present invention—obtained as described above—are not known in the prior art; particularly, many of the above-mentioned anthropometric units are not used at all in the prior art; other ones (for example, the fist) are sometimes used, but with reference to statistical average values, and they are not customized, being therefore completely unsuitable to lead to a sufficiently accurate quantification of quantities.

Once multiple customized anthropometric measurement units have been provided, they can be used advantageously and with a considerable flexibility for the definition of quantities: for example, a handful of rice, or a fist of leafy vegetables, or a slice (e.g., a bread slice large as the hand area and having the height of a finger), or a steak (e.g., large as half a hand, where the reference is the hand area, and having a thickness of two fingers) and so on. The resulting quantity definition is characterized by a satisfactory degree of precision, by virtue of the fact that the anthropometric units are customized, while it may easily and efficiently applied by the person who has to implement the dietary/food indication, or simply identify a portion of a food.

To the embodiments of the method and the system for a customized definition of food quantities based on the determination of anthropometric parameters, described above, those of ordinary skill in the art, in order to meet contingent needs, will be able to make modifications, adaptations, and replacements of elements with other functionally equivalent ones, also in combination with the prior art, also creating hybrid implementations, without departing from the scope of the following claims. Each of the characteristics described as belonging to a possible embodiment may be implemented independently from the other embodiments described. It is further noticed that the term “comprising” does not exclude other elements' or steps, the term “a/an” or “one” does not exclude a plurality. Furthermore, the figures are not necessarily in scale; on the contrary, importance is generally given to illustrating the principles of the present invention.

APPENDIX
TRANSLATION OF THE WRITINGS IN THE FIGURES

| | |
|---|---|
| FIG. 4 | (41) “ACQUISISCI Immagine” = “ACQUIRE image” |
| | (42) “Annulla” = “Cancel” |
| FIG. 6 2 | (44a) “Definire Piano d'Appoggio” = “Define support plane” |
| | (44b) “Definire Area Lettura” = “Define Reading Area” |
| | (43) “Cliccare la linea orizzontale di taglio polso” = “”Clicking |
| | the wrist cut horizontal line” |
| | (46) “Annulla” = “Cancel” |
| FIG. 7 | (45) “Conferma” = “Confirm” |
| | (46) “Annulla” = “Cancel” |
| FIG. 8 | (45) “Conferma” = “Confirm” |
| | (46) “Annulla” = “Cancel” |
| FIG. 9 | (45) “Conferma” = “Confirm” |
| | (46) “Annulla” = “Cancel” |
| FIG. 10 | (45) “OK” = “OK” |
| | (46) “Annulla” = “Cancel” |
| | (47) “Taglia polso” = “Wrist cut” |
| | (57) “Superficie tot. (cm²)” = “Total Area (cm²)” |
| | (48) “Seleziona” = “Select” |
| | “Larghezza dito (indice, medio, anulare)” = “Finger width (index, |
| | middle, annular)” |
| | (56) “Larghezza (cm)” = “Width (cm)” |
| | (49) “Seleziona” = “Select” |
| | “Altezza dito indice” = “Index Finger Height” |
| | (55) “Misura (cm)” = “Measurement (cm)” |
| | (50) “Seleziona” = “Select” |
| | “Superficie mano senza pollice” = “Area of hand without thumb” |
| | (54) “Misura (cm)” = “Measurement (cm)” |
| | (52) “Seleziona” = “Select” |
| | “Separazione dorso/dita” = “Back/Fingers separation” |
| | (53) “Larg. Mano (cm)” = “Hand Width (cm)” |

1: A method of definition of a food quantity for a person, comprising:
acquiring digital data relating to a body portion of the person;
processing the acquired digital data to determine at least one anthropometric parameter of the person;
defining at least one customized measurement unit based on said at least one anthropometric parameter;
defining said food quantity based on said at least one customized measurement unit.

2: The method according to claim 1, wherein the digital data acquisition operation comprises:
defining a spatial reference system;
arranging the body portion in a known position with respect to said spatial reference system;
acquiring as digital data a digital representation of the body portion with respect to said spatial reference system.

3: The method according to claim 2, wherein:
the operation of defining a spatial reference system comprises providing a support suitable to define the spatial reference system;
the operation of arranging comprises arranging the body portion on said support;
the operation of acquiring a digital representation comprises acquiring a digital representation of the body portion and of at least one part of the support.

4: The method according to claim 2, wherein the digital data processing operation comprises:
determining a reference coordinate system corresponding to said spatial reference system;
recognizing in the acquired digital representation a plurality of points corresponding to the body portion;
estimating the coordinates of said plurality of points corresponding to the body portion, with respect to the determined reference coordinate system;
calculating the at least one anthropometric parameter based on the estimated coordinates.

5: The method according to claim 1, wherein the at least one anthropometric parameter corresponds to a monodimensional dimension, or to a bidimensional dimension, or to a tridimensional dimension of the body portion, and wherein the operation of defining at least one customized measurement unit comprises defining a length measurement unit, or an area measurement unit, or a volume measurement unit, respectively.

6: The method according to claim 1, wherein a plurality of anthropometric parameters is determined, each of which corresponding to a monodimensional dimension, or to a bidimensional dimension, or to a tridimensional dimension of the body portion, and wherein the operation of defining at least one customized measurement unit comprises defining, respectively, a length, or area, or volume measurement unit.

7: The method according to claim 5, wherein the operation of defining the food quantity comprises:
defining the food quantity in terms of a standard volume or area or length unit;
converting the standard volume or area or length unit into said customized volume, area or length measurement unit, respectively;
expressing the food quantity in terms of said customized volume, area or length measurement unit.

8: The method according to claim 1, wherein the body portion is a hand.

9: The method according to claim 5, wherein the body portion is a hand and wherein said volume measurement unit corresponds to the volume of the stretched hand with closed fingers, or to the volume of the hand arranged as a clenched fist, or to the volume of the hand arranged as a flattened fist, or to the volume of the fingers, or to a volume obtained by multiplying a measured surface by a measured monodimensional length.

10: The method according to claim 3 wherein:
the support is characterized by a background colour that is different from a nominal colour of the body portion;
the spatial reference system is a bidimensional reference defined by a plurality of reference point marked on the support with a reference colour that is different from said background colour and from the colour of the body portion;
the respective reference coordinate system is a system of bidimensional coordinates based on the coordinates of each of said plurality of reference points;
the acquired digital representation is a bidimensional image composed by pixels, acquired by a video camera;
wherein the method further comprises:
examining the pixels of the image to determine the colour thereof;
carrying out respective comparisons between the colour determined for each of the examined pixels and each of the background colour, the reference colour, and a predefined expected colour of the body portion;
recognizing the plurality of reference points and the plurality of points belonging to the body portion, based on said comparisons.

11: The method according to claim 10, wherein the operation of calculating the anthropometric parameter comprises:
calculating a distance between two end points among the points recognized as belonging to the body portion, and considering the calculated distance as a length of the body portion;
or:
calculating the sum of the single areas of the pixels corresponding to the points recognized as belonging to the body portion, and considering the area calculated as an area of the body portion;
or:
estimating the volume of the body portion, by a predefined algorithm, based on said calculated area and length of the body portion.

12: The method according to claim 3, wherein:
the support is on an support plane that is inclined by a known angle ranging between 0° and 90° with respect to the horizontal plane;
the spatial reference system is a tridimensional reference defined by a reference plane, related to said support plane;
the respective reference coordinate system is an equation representative of said reference plane;
the acquired digital representation is a tridimensional representation composed of pixels having tridimensional coordinates, acquired by a sensor devices provided with depth sensors;
wherein the method further comprises:
determining a first depth matrix of a zone scanned by the sensor device, in the absence of the body portion on the support;
determining a second depth matrix of the said zone scanned by the sensor device, in the presence of the body portion on the support;
recognizing the plurality of points belonging to the body portion, based on a processing operation performed on said first depth matrix and second depth matrix.

13: The method according to claim 12, wherein the operation of calculating an anthropometric parameter comprises:
calculating a distance between two end points among the points recognized as belonging to the body portion, and considering the distance calculated as a length of the body portion; or:
calculating the sum of the single areas of the pixels corresponding to the points recognized as belonging to the body portion, and considering the area calculated as an area of the body portion; or:
calculating the sum of the volumes of the single solids of the pixels corresponding to the points recognized as belonging to the body portion, and considering the calculated volume as a volume of the body portion; each of said single solids being a solid defined by the surface of the respective pixel, the projection surfaces of the boundary of the pixel surface, as seen by the sensor device, and the surface of the projection of said pixel on the support plane.

14: The method according to claim 1, further comprising:
indicating, by a user, anthropometric parameters the measurement of which is desired;
establishing, by the user, criteria to define boundary conditions for the desired measurements;
carrying out a further processing, by the processing means, on the acquired data, to obtain one or more anthropometric parameters, based on post-processing calculations, and taking into account the criteria established by the user;
wherein said each of said one or more anthropometric parameters obtained in post-processing belongs to a group comprising: hand width, hand length, length of at least one of the fingers, width of at least one of the fingers, height of at least one of the fingers, span length, area of at least one of the fingers, hand area, hand area without thumb, area of the hand back, area of the hand palm, volume of the stretched hand with dosed fingers, volume of the clenched fist, volume of the flattened fist.

15: The method according to claim 1, wherein:
the operations of calculating a distance between two end points, or calculating the sum of the single areas, or calculating the sum of the volumes of the single solids are iteratively repeated;
the respective length of the body portion, or area of the body portion, or volume of the body portion, are calculated as an average or a standard deviation of the results of a plurality of said iterative repetitions.

16: A system for the definition of a food quantity for a person, comprising:
digital data acquisition means, configured to acquire digital data relating to a body portion of the person;
processing means, configured to perform the operations of:
processing the acquired digital data,
determining at least one anthropometric parameter of the person,
defining at least one customized measurement unit based on the at least one anthropometric parameter,
and defining said food quantity based on said at least one customized measurement unit.

17: The system according to claim 16, wherein said digital data acquisition means comprise a video camera.

18: The system according to claim 16, wherein said digital data acquisition means comprise a sensor device provided with depth sensors.

19: The system according to claim 16, wherein said processing means comprise at least one computer or smartphone or laptop configured to operate based on programs and algorithms accessible thereto, and said processing means are further configured to store the acquired data and to operate a post-processing on said stored data.
